(19) United States
(12) Patent Application Publication
(10) Pub. No.: US 2017/0067566 A1
(43) Pub. Date: Mar. 9, 2017

(54) Fluid Valve

(71) Applicant: Gimpel USA Inc., Rancho Cucamonga, CA (US)

(72) Inventors: Yingxu WANG, Nanjing (CN); Zhiliang YANG, Nanjing (CN)

(73) Assignee: Gimpel USA Inc.

(21) Appl. No.: 15/055,347

(22) Filed: Feb. 26, 2016

(30) Foreign Application Priority Data
Sep. 6, 2015 (CN) 201520683993.7

(51) Int. Cl. F16K 5/06; F16K 5/12

(52) U.S. Cl. CPC F16K 5/0605; F16K 5/12

(57) ABSTRACT

A fluid valve includes a main valve body, a valve seat, a valve core and a valve actuator. The main valve body has a fluid inlet, and a fluid outlet. The valve core includes a core body having a main passage channel, a core inlet, and a core outlet. The core body has a curved guiding surface for forming a residual passage channel between the curved guiding surface and the valve seat. The valve core may be moved between a fully opened position, a partially opened position, and a fully closed position. In the partially opened position, the valve core is moved such that the fluid inlet is arranged to communicate with to the core inlet and the residual passage channel for allowing passage of fluid from the fluid inlet to the fluid outlet through the main passage channel and the residual passage channel.

### BACKGROUND OF THE PRESENT INVENTION

Field of Invention

The present invention relates to a fluid valve, and more particularly to a fluid valve comprising a valve core which has at least one curved guiding surface for forming at least one residual passage channel.

Description of Related Arts

Referring to FIG. 1 to FIG. 5 of the drawings, a conventional fluid valve usually comprises a valve body 10P having a valve cavity 13P, a valve core 20P received in the valve body 10P, a valve seat 40P provided in the valve cavity 13P to support the valve core 20P, and an actuator 30P operatively mounted on the valve body 10P to selectively move the valve core 20P. The valve body 10P usually has a fluid inlet 11P, and an opposed fluid outlet 12P such that the valve cavity 13P is formed between the fluid inlet 11P and the fluid outlet 12P. The valve core 20P usually has a fluid passage channel 21P for allowing passage of fluid. The actuator 30P may be arranged to actuate the valve core 30P to move between an opened position and a closed position. In the opened position, the valve core 20P is rotated to allow fluid to pass from the fluid inlet 11P to the fluid outlet 12P through the passage channel 21P. In the closed position, the valve core 20P is rotated so that fluid is prevented from entering the passage channel 21P from the fluid inlet 11P. In other words, the fluid inlet 11P and the fluid outlet 12P are selectively blocked from each other by actuation of the actuator 30P.

The above-mentioned conventional fluid valve suffers from several disadvantages. First, when fluid passes through the fluid valve, unwanted substances or particles may be trapped inside the valve cavity 13P, particularly at a positions between the valve core 20P and the valve seat 40P. These unwanted substances or particles may prevent the valve core 20P from being rotated or moved smoothly within the valve cavity 13P. More seriously, these unwanted substances or particulates may cause damage to the valve core 20P or the valve seat 40P.

Second, the valve core 20P usually is in contact with the valve seat 40P when the valve core 20P is rotated in the valve cavity 13P. This situation is shown in FIG. 4 of the drawings. When this occurs, the valve core 20P can become very difficult to be rotated. This situation may be worsen when the unwanted substances or particles are trapped in the valve cavity 13P.

As a result, there is a need for a fluid valve which does not suffer from the above-mentioned deficiencies.

### SUMMARY OF THE PRESENT INVENTION

Certain variations of the present invention provide a fluid valve comprising a valve core which has at least one curved guiding surface for forming at least one residual passage channel.

Certain variations of the present invention provide a fluid valve having at least one residual passage channel which provides an additional route for allowing passage of fluid when the fluid valve is partially opened. As a result, unwanted substances or particulates are prevented from being trapped in the fluid valve.

In one aspect of the present invention, it provides a fluid valve, comprising:

a main valve body having at least one fluid inlet, at least one fluid outlet opposite to the fluid inlet, and a valve cavity formed between the fluid inlet and the fluid outlet;

a valve seat supported in the valve cavity;

a valve core which comprises a core body movably supported in the valve cavity, the core body having a main passage channel, a core inlet communicating with the main passage channel, and a core outlet communicating with the main passage channel, the core body having at least one curved guiding surface for forming at least one residual passage channel between the curved guiding surface and the valve seat; and

a valve actuator connected to the main valve body and the valve core to move the valve core between a fully opened position, a partially opened position, and a fully closed position, wherein in the fully closed position, the valve core is moved such that the core inlet is blocked from communicating with the fluid inlet so that fluid is prevented from passing from the fluid inlet to the fluid outlet, wherein in the partially opened position, the valve core is moved such that the fluid inlet is arranged to communicate with the core inlet and the residual passage channel, and the fluid outlet is arranged to communicate with the core outlet and the residual passage channel so as to allow passage of fluid from the fluid inlet to the fluid outlet through the main passage channel and the residual passage channel, wherein in the fully opened position, the valve core is moved such that the fluid inlet is arranged to communicate only with the core inlet, and the fluid outlet is arranged to communicate only with the core outlet so as to allow passage of fluid from the fluid inlet to the fluid outlet through the main passage channel without passing through the residual passage channel.

This summary presented above is provided merely to introduce certain concepts and not to identify any key or essential features of the claimed subject matter.

### BRIEF DESCRIPTION OF THE DRAWINGS

FIG. 1 is a side view of a conventional fluid valve.

FIG. 2 is a schematic diagram of a valve core of the conventional fluid valve, illustrating an external appearance of the valve core.

FIG. 3 is a side view of the valve core of the conventional fluid valve.

FIG. 4 is a top sectional schematic diagram of the conventional fluid valve, illustrating that fluid passes through the conventional fluid valve.

FIG. 5 is a top sectional schematic diagram of the conventional fluid valve, illustrating that fluid valve is closed.

FIG. 6 is a sectional side view of a fluid valve according to a preferred embodiment of the present invention.

FIG. 7 is a front view of a valve core of the fluid valve according to the preferred embodiment of the present invention.

FIG. 8 is a side view of the valve core of the fluid valve according to the preferred embodiment of the present invention.

FIG. 9 is a top sectional schematic diagram of the fluid valve according to the preferred embodiment of the present invention, illustrating that the valve core is in a partially opened position.

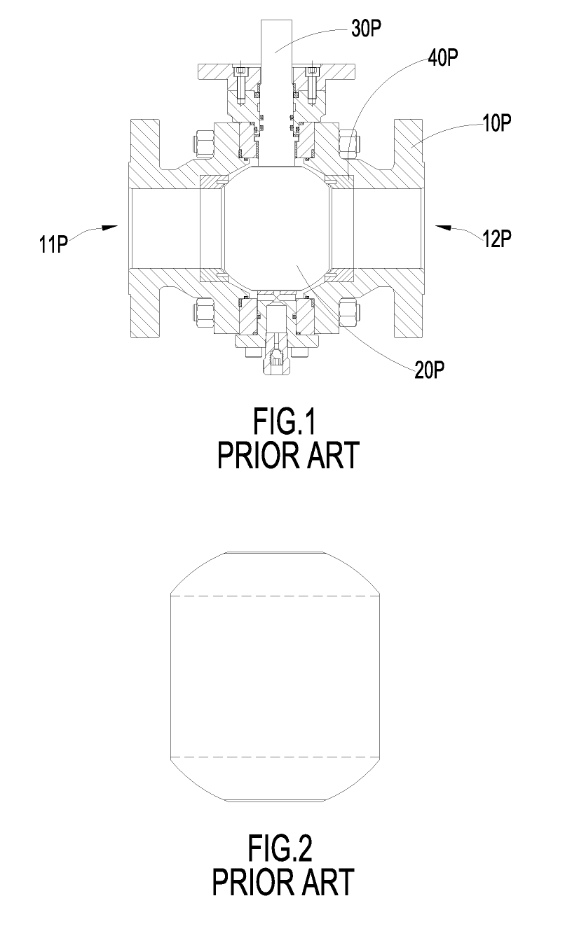

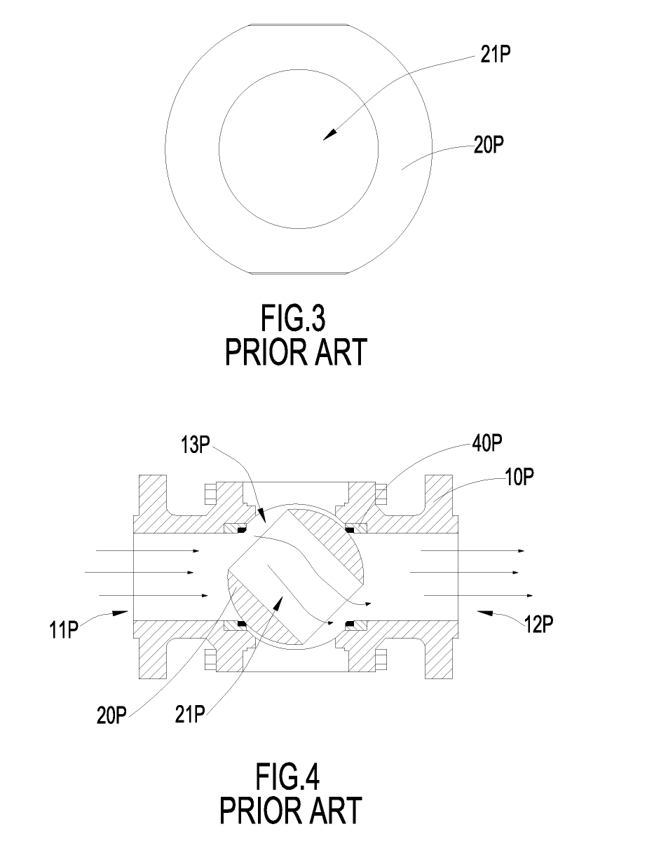

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

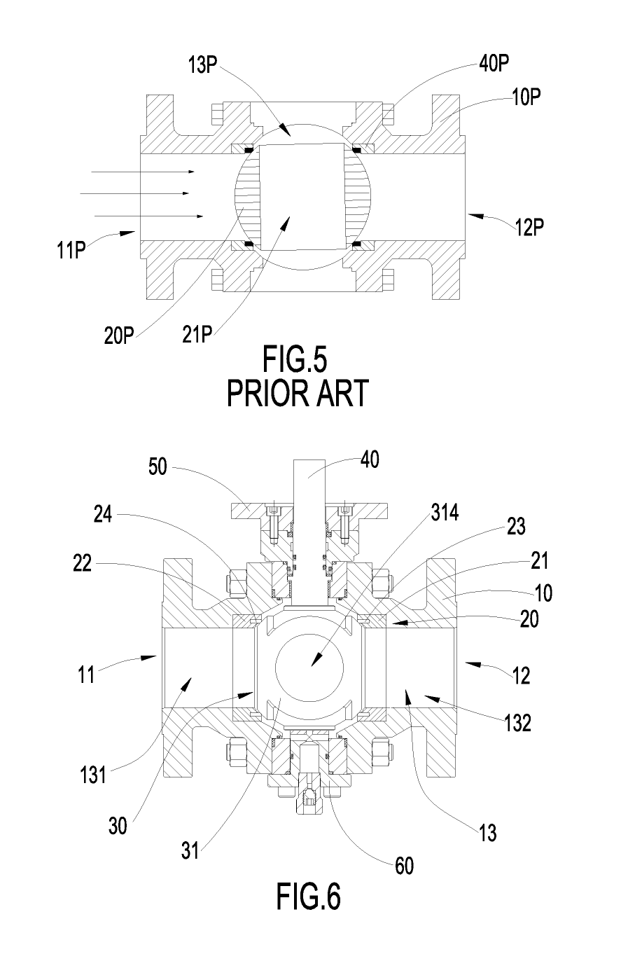

Referring to FIG. 6 to FIG. 9 of the drawings, a fluid valve according to a preferred embodiment of the present invention is illustrated. Broadly, the fluid valve may comprise a main valve body 10, a valve seat 20, a valve core 30, and a valve actuator 40. The fluid valve is for selectively allowing or blocking fluid from passing through it. The fluid may be gas or liquid and may be configured for industrial use.

The main valve body 10 may have at least one fluid inlet 11, at least one fluid outlet 12 opposite to the fluid inlet 11, and a valve cavity 13 formed between the fluid inlet 11 and the fluid outlet 12. The valve seat 20 may be supported in the valve cavity 13 of the main valve body 10.

The valve core 30 may comprise a core body 31 movably supported in the valve cavity 13. The core body 31 may have a main passage channel 311, a core inlet 312 communicating with the main passage channel 311, and a core outlet 313 communicating with the main passage channel 311 at another side thereof. The core body 31 may have at least one curved guiding surface 314 for forming at least one residual passage channel 32 between the curved guiding surface 314 and the valve seat 20.

The valve actuator 40 may be connected to the main valve body 10 and the valve core 30 to move the valve core 30 between a fully opened position, a partially opened position, and a fully closed position. In the fully closed position, the valve core 30 is moved such that the core inlet 312 is blocked from communicating with the fluid inlet 11 so that fluid is prevented from passing from the fluid inlet 11 to the fluid outlet 12.

In the partially opened position, the valve core 30 is moved such that the fluid inlet 11 is arranged to communicate with the core inlet 312 and the residual passage channel 32, and the fluid outlet 12 is arranged to communicate with the core outlet 313 and the residual passage channel 32 so as to allow passage of fluid from the fluid inlet 11 to the fluid outlet 12 through the main passage channel 311 and the residual passage channel 32.

In the fully opened position, the valve core 30 is moved such that the fluid inlet 11 is arranged to communicate only with the core inlet 312, and the fluid outlet 12 is arranged to communicate only with the core outlet 313 so as to allow passage of fluid from the fluid inlet 11 to the fluid outlet 12 through the main passage channel 311 without passing through the residual passage channel 32.

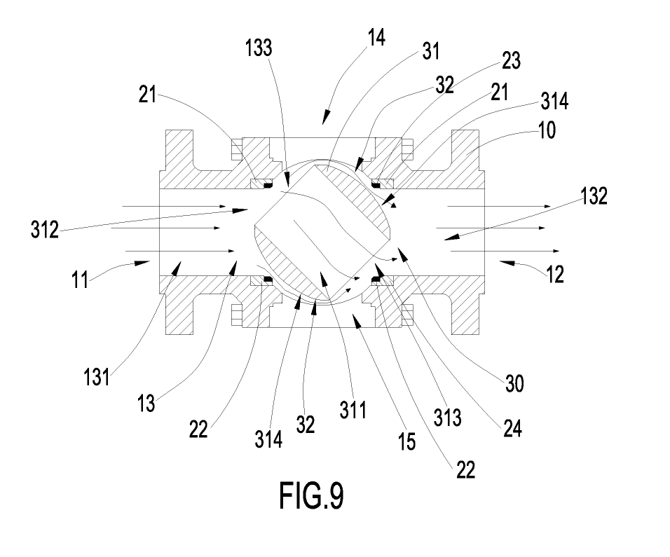

According to the preferred embodiment of the present invention, the fluid valve may be configured for industrial use and for selectively regulating the flow of fluid through the fluid valve. The main valve body 10 may have one fluid inlet 11 and one fluid outlet 12 which is positioned opposite to the fluid inlet 11 along a longitudinal direction of the main valve body 10. The valve seat 20 and the valve core 30 may be received in the receiving cavity 13 to divide the receiving cavity 13 into an inlet compartment 131 formed between the valve core 30 and the fluid inlet 11, an outlet compartment 132 formed between the valve core and the fluid outlet 12, and a core compartment 133 formed as a space between the inlet compartment 131 and the outlet compartment 132. As shown in FIG. 6 and FIG. 9 of the drawings, the inlet compartment 131 and the outlet compartment 132 may be formed at two side portions of the main valve body 10 respectively, while the valve seat 20 and the valve core 30 may be positioned at the core compartment 133 of the main valve body 10.

Furthermore, the main valve body 10 may have a top opening 14 and a bottom opening 15 communicating with the receiving cavity 13. The fluid valve of the present invention may further comprise a top covering member 50 and a ventilating valve 60 provided at the top opening 14 and the bottom opening 15 respectively. Thus, the top covering member 50 and the ventilating valve 60 may be used to cover and controllably seal the top opening 14 and the bottom opening 15 respectively.

The valve seat 20 may comprise a first supporting member 21 and a second supporting member 22 provided in the receiving cavity 13 at two inner end portions of the inlet compartment 131 and the outlet compartment 132 respectively. In other words, first supporting member 21 and the second supporting member 22 are provided near the boundary between core compartment 133 and the inlet compartment 131, and the boundary between the core compartment 133 and the outlet compartment 132. Furthermore, the valve seat 20 may further comprise a first sealing ring 23 and a second sealing ring 24 provided on the first supporting member 21 and the second supporting member 22 respectively for providing sealing to the core compartment 132 when the valve core 30 is in the fully closed position and the fully opened position. It is worth mentioning that the valve seat 20 may only comprise the first and the second supporting member 21, 22 or the first and the second sealing ring 23, 24, or a combination of these. The actual combination depends on specific sealing requirements.

The valve actuator 40 may be configured as an elongated structure, and may be movably connected to a top portion of the main valve body 10, the top covering member 50 and the valve core 30 in such a manner that the valve actuator 40 may be configured to drive the valve core 30 to rotate in the receiving cavity 13 so as to be moved between the fully opened position, the partially opened position, and the fully-closed position.

The main passage channel 311 of the core body 31 may be configured as a through channel extending between two sides of the core body 31. The core inlet 312 and the core outlet 313 may be formed at two ends of the main passage channel 311 (as shown in FIG. 6 and FIG. 9 of the drawings). When the valve core 30 is in the fully opened position, the core inlet 312 may communicate with the inlet compartment 131 while the core outlet 313 may communicate with the outlet compartment 132 so that fluid may be capable of passing through the fluid inlet 11, the inlet compartment 131, the main passage channel 311, the outlet compartment 132, and the fluid outlet 12. The residual passage channel 311 is substantially blocked by the valve seat 20 so that fluid may be guided to pass through the main passage channel 311 only and the fluid may be prevented from passing through the residual passage channel 32.

When the valve core 30 is in the partially opened position, the core inlet 312 may communicate with the inlet compartment 131 while the core outlet 313 may communicate with the outlet compartment 132 so that fluid may be capable of passing through the fluid inlet 11, the inlet compartment 131, the main passage channel 311, the outlet compartment 132, and the fluid outlet 12. At the partially opened position, moreover, the residual passage channel 311 is not fully blocked by the valve seat 20 so that fluid may pass through the residual passage channels 32 formed between the curved guiding surfaces 314, 315 and the valve body 10 or the valve seat 20.

The core body 31 may two four (but at least one) curved guiding surfaces 314 formed on external surfaces of the core body 31 for forming a corresponding number of residual passage channels 32 in the valve body 10. According to the preferred embodiment of the present invention, the two curved guiding surfaces 314 (as mentioned above) may be formed on two side external surfaces of the core body 31 respectively (see FIG. 9 of the drawings).

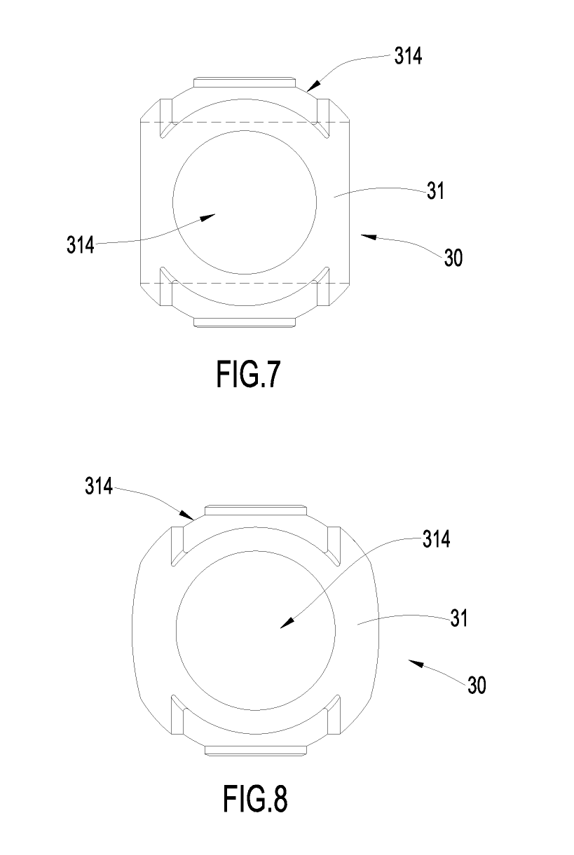

As shown in FIG. 7 to FIG. 9 of the drawings, each of the curved guiding surfaces 314 may have a predetermined radius of curvature which forms the corresponding residual passage channel 32. When the fluid passes through the curved guiding surfaces 314 at certain speed, the fluid may actually help cleaning the curved guiding surfaces 314 by flushing dirt or unwanted substances from external surfaces of the core body 31.

The core body 31 may further have two curved guiding surfaces 314 formed on a top surface and a bottom surfaces of the core body 31 for providing two additional residual passage channels 32 in the valve body 10. As shown in FIG. 8 of the drawings, a radius of curvature of the two additional curved guiding surfaces 314 (i.e. the curved guiding surfaces 314 formed on the top and a bottom surface of the core body 31) may be slightly smaller than that of the curved guiding surfaces 314 which are formed on the external side surfaces of the core body 31. In other words, the additional curved guiding surfaces 314 may be less curved when compared with the curved guiding surfaces 314 formed on two external side surfaces of the core body 31.

Note that the number of the curved guiding surfaces 314 and therefore the number of the residual passage channels 32 may be varied depending on the circumstances in which the present invention is operated. In addition, the radius of curvature of each of the curved guiding surfaces 314 may also be varied depending on the circumstances in which the present invention is operated. The preferred embodiment illustrates that there may be altogether four curved guiding surfaces 314 for forming four residual passage channels 32. However, other number of curved guiding surfaces 314 may also be possible.

The present invention, while illustrated and described in terms of a preferred embodiment and several alternatives, is not limited to the particular description contained in this specification. Additional alternative or equivalent components could also be used to practice the present invention.

What is claimed is:

1. A fluid valve, comprising:
a main valve body having at least one fluid inlet, at least one fluid outlet opposite to said fluid inlet, and a valve cavity formed between said fluid inlet and said fluid outlet;
a valve seat supported in said valve cavity ;
a valve core which comprises a core body movably supported in said valve cavity, said core body having a main passage channel, a core inlet communicating with said main passage channel, and a core outlet communicating with said main passage channel, said core body having at least one curved guiding surface for forming at least one residual passage channel between said curved guiding surface and said valve seat; and
a valve actuator connected to said main valve body and said valve core to move said valve core between a fully opened position, a partially opened position, and a fully closed position, wherein in said fully closed position, said valve core is moved such that said core inlet is blocked from communicating with said fluid inlet so that fluid is prevented from passing from said fluid inlet to said fluid outlet, wherein in said partially opened position, said valve core is moved such that said fluid inlet is arranged to communicate with said core inlet and said residual passage channel, and said fluid outlet is arranged to communicate with said core outlet and said residual passage channel so as to allow passage of fluid from said fluid inlet to said fluid outlet through said main passage channel and said residual passage channel, wherein in said fully opened position, said valve core is moved such that said fluid inlet is arranged to communicate only with said core inlet, and said fluid outlet is arranged to communicate only with said core outlet so as to allow passage of fluid from said fluid inlet to said fluid outlet through said main passage channel without passing through said residual passage channel.

2. The fluid valve, as recited in claim 1, wherein said valve core is received in said receiving cavity to divide said receiving cavity into an inlet compartment formed between said valve core and said fluid inlet, an outlet compartment formed between said valve core and said fluid outlet, and a core compartment formed as a space between said inlet compartment and said outlet compartment in said main valve body.

3. The fluid valve, as recited in claim 2, wherein said main passage channel of said core body is configured as a through channel extending between two sides of said core body, said core inlet and said core outlet being formed at two ends of said main passage channel respectively, wherein when said valve core is in said fully opened position, said core inlet is arranged to communicate with said inlet compartment while said core outlet is arranged to communicate with said outlet compartment so that said fluid is capable of passing through said fluid inlet, said inlet compartment, said main passage channel, said outlet compartment, and said fluid outlet, said residual passage channel being substantially blocked by said valve seat.

4. The fluid valve, as recited in claim 3, wherein when said valve core is in said partially opened position, said core inlet is arranged to communicate with said inlet compartment while said core outlet is arranged to communicate with said outlet compartment so that fluid is capable of passing through said fluid inlet, said inlet compartment, said main passage channel and said residual passage channel, said outlet compartment, said fluid outlet.

5. The fluid valve, as recited in claim 2, wherein said inlet compartment and said outlet compartment are formed at two side portions of said main valve body respectively, said valve seat and said valve core being positioned at said core compartment of said main valve body.

6. The fluid valve, as recited in claim 4, wherein said inlet compartment and said outlet compartment are formed at two side portions of said main valve body respectively, said valve seat and said valve core being positioned at said core compartment of said main valve body.

7. The fluid valve, as recited in claim 2, wherein said main valve body has a top opening and a bottom opening communicating with said receiving cavity, said fluid valve further comprising a top covering member and a ventilating valve provided at said top opening and said bottom opening respectively.

8. The fluid valve, as recited in claim 4, wherein said main valve body has a top opening and a bottom opening communicating with said receiving cavity, said fluid valve further comprising a top covering member and a ventilating valve provided at said top opening and said bottom opening respectively.

9. The fluid valve, as recited in claim 6, wherein said main valve body has a to top opening and a bottom opening communicating with said receiving cavity, said fluid valve further comprising a top covering member and a ventilating valve provided at said top opening and said bottom opening respectively.

10. The fluid valve, as recited in claim 2, wherein said valve seat comprises a first supporting member and a second supporting member provided in said receiving cavity at two inner end portions of said inlet compartment and said outlet compartment respectively.

11. The fluid valve, as recited in claim 4, wherein said valve seat comprises a first supporting member and a second supporting member provided in said receiving cavity at two inner end portions of said inlet compartment and said outlet compartment respectively.

12. The fluid valve, as recited in claim 6, wherein said valve seat comprises a first supporting member and a second supporting member provided in said receiving cavity at two inner end portions of said inlet compartment and said outlet compartment respectively.

13. The fluid valve, as recited in claim 2, wherein said valve actuator is movably connected to a top portion of said main valve body, said top covering member and said valve core in such a manner that said valve actuator is configured to drive said valve core to rotate in said receiving cavity so as to be moved between said fully opened position, said partially opened position, and said fully-closed position.

14. The fluid valve, as recited in claim 6, wherein said valve actuator is movably connected to a top portion of said main valve body, said top covering member and said valve core in such a manner that said valve actuator is configured to drive said valve core to rotate in said receiving cavity so as to be moved between said fully opened position, said partially opened position, and said fully-closed position.

15. The fluid valve, as recited in claim 12, wherein said valve actuator is to movably connected to a top portion of said main valve body, said top covering member and said valve core in such a manner that said valve actuator is configured to drive said valve core to rotate in said receiving cavity so as to be moved between said fully opened position, said partially opened position, and said fully-closed position.

16. The fluid valve, as recited in claim 2, wherein core body has altogether four said curved guiding surfaces for forming a corresponding number of residual passage channels in said valve body, said curved guiding surfaces being formed on a top external surface, a bottom external surface, and two side external surfaces of said core body respectively.

17. The fluid valve, as recited in claim 12, wherein core body has altogether four said curved guiding surfaces for forming a corresponding number of residual passage channels in said valve body, said curved guiding surfaces being formed on a top external surface, a bottom external surface, and two side external surfaces of said core body respectively.

18. The fluid valve, as recited in claim 15, wherein core body has altogether four said curved guiding surfaces for forming a corresponding number of residual passage channels in said valve body, said curved guiding surfaces being formed on a top external surface, a bottom external surface, and two side external surfaces of said core body respectively.

19. The fluid valve, as recited in claim 11, wherein said valve seat further comprises a first sealing ring and a second sealing ring provided on said first supporting member and the second supporting member respectively for providing sealing to the core compartment when said valve core is in said fully closed position and said fully opened position.

20. The fluid valve, as recited in claim 12, wherein said valve seat further comprises a first sealing ring and a second sealing ring provided on said first supporting member and the second supporting member respectively for providing sealing to the core compartment when said valve core is in said fully closed position and said fully opened position.
